(19) United States
(12) Patent Application Publication
(10) Pub. No.: US 2008/0165232 A1
(43) Pub. Date: Jul. 10, 2008

(54) INK CARTRIDGE

(76) Inventor: Kenneth Yuen, San Gabriel, CA (US)

Correspondence Address: MERCHANT & GOULD PC, P.O. BOX 2903, MINNEAPOLIS, MN, 55402-0903, US

(21) Appl. No.: 11/621,847

(22) Filed: Jan. 10, 2007

(51) Int. Cl. B41J 2/175

(52) U.S. Cl. 347/86

(57) ABSTRACT

An ink container includes a housing that defines an ink reservoir, an air vent in air flow communication with the ink reservoir, and an ink outlet in ink flow communication with the ink reservoir. The air vent provides air flow communication between atmosphere and the ink reservoir. The ink outlet provides an ink flow path out of the ink reservoir through a leading surface of the housing. The ink outlet and air vent can be positioned on different sides of the cartridge or on the same side of the housing. The leading surface faces in a generally horizontal direction. The leading surface can include a contoured shape such as a convex shape.

### TECHNICAL FIELD

The present invention generally relates to ink containers, and more specifically relates to printer cartridges for ink jet printers.

### BACKGROUND

Ink jet printers are a popular form of printer used with computers and similar applications involving document printing or graphics preparation. Typical ink jet printers have replaceable ink cartridges. Different styles of ink cartridges have structure and features that improve performance and usability of the ink cartridges for a given printer. For example, the type of ink flow and air flow features can alter the ink flow characteristics of ink drawn out of the ink cartridge. One style of ink cartridge includes a sealed ink chamber without an air inlet. The walls of the ink chamber are flexible and are depressed under vacuum pressure conditions inside the ink cartridge that are generated as ink flows out of the ink chamber. A biasing force is sometimes applied to the flexible ink chamber walls to ensure initiation of ink flow out of the cartridge. Another ink cartridge style includes an ink chamber that is in air flow communication with an exterior of the ink chamber through an air vent to maintain an internal atmospheric pressure condition. Air is drawn into the ink chamber as ink flows out of the ink chamber. The ink chamber walls are rigid. A valve structure on the air vent may be required in order to prevent ink from leaking out of the ink chamber.

In some cases, features of the ink cartridge housing can impact the ease or difficulty for the user handling the ink cartridge and mounting the ink cartridge in the printer. Handles and latching features are sometimes used to assist a user in handling the ink cartridge.

### SUMMARY

One aspect of the present disclosure relates to an ink cartridge for use in an ink jet printer. The ink cartridge includes a housing that defines an ink reservoir, an air vent in air flow communication with the ink reservoir, and an ink outlet in ink flow communication with the ink reservoir. A leading surface of the housing faces in a generally horizontal direction. The leading surface is oriented generally in alignment with a vertical plane. The leading surface can include a contoured structure such as a convex or concave surface. Alternatively, the leading surface is generally planar and oriented at an angle relative to the vertical plane. The ink outlet is typically positioned on the leading surface. The ink outlet and air vent are preferably positioned on different walls of the housing.

Another aspect of the present disclosure relates to latching surfaces of the ink cartridge that are defined by the housing and configured for engagement by a latching member of the printer that retains ink cartridges in an operation position. The latching surfaces typically face in a direction opposite to the direction in which the leading surface faces. The latching surfaces can include a contoured surface such as, for example, a convex or concave surface. The latching surfaces can be arranged in a non-parallel arrangement relative to the leading surface.

Another aspect of the present disclosure relates to an air valve arrangement for an ink cartridge. The air valve arrangement is actuatable from a leading edge side of the cartridge housing to initiate air flow communication with an ink chamber of the ink cartridge. The valve arrangement includes an air vent through which air flows into the ink chamber upon actuation of the air valve arrangement. The air vent is positioned on a side of the ink cartridge different from the leading edge side.

The above summary is not intended to describe each disclosed embodiment or every implementation of the inventive aspects disclosed herein. Figures in the detailed description that follow more particularly describe features that are examples of how certain inventive aspects may be practiced. While certain embodiments are illustrated and described, it will be appreciated that the invention/inventions of the disclosure are not limited to such embodiments.

### BRIEF DESCRIPTION OF THE DRAWINGS

FIG. 1 is a schematic front perspective view of an example ink cartridge in accordance with inventive principles disclosed herein;

FIG. 2 is a schematic side perspective view of the ink cartridge shown in FIG. 1;

FIG. 3 is a schematic bottom perspective view of the ink cartridge shown in FIG. 1;

FIG. 4 is a schematic front plan view of the ink cartridge shown in FIG. 1;

FIG. 5 is a schematic cross-sectional view of the ink cartridge shown in FIG. 4 taken along cross-sectional indicators 5-5;

FIG. 6 is a schematic cross-sectional view of the ink cartridge shown in FIG. 4 taken along cross-sectional indicators 6-6;

FIG. 7 is a schematic front perspective view of another example ink cartridge in accordance with inventive principles disclosed herein;

FIG. 8 is a schematic rear perspective view of the ink cartridge shown in FIG. 7;

FIG. 9 is a schematic front perspective view of another example ink cartridge in accordance with inventive principles disclosed herein;

FIG. 10 is a rear perspective view of the ink cartridge shown in FIG. 9;

FIG. 11 is a schematic bottom perspective view of another example ink cartridge in accordance with inventive principles disclosed herein;

FIG. 12 is a schematic front plan view of the ink cartridge shown in FIG. 11;

FIG. 13 is a schematic side plan view of the ink cartridge shown in FIG. 1;

FIG. 14 is a schematic cross-sectional view of the ink cartridge shown in FIG. 12 taken along cross-sectional indicators 14-14;

FIG. 15 is a schematic bottom perspective view of another example ink cartridge in accordance with inventive principles disclosed herein;

FIG. 16 is a schematic front plan view of the ink cartridge shown in FIG. 15;

FIG. 17 is a schematic side plan view of the ink cartridge shown in FIG. 15;

FIG. 18 is a schematic cross-sectional view of the ink cartridge shown in FIG. 16 taken along cross-sectional indicators 18-18;

FIG. 19 is a schematic front perspective view of another example ink cartridge in accordance with inventive principles disclosed herein;

FIG. 20 is a schematic rear perspective view of the ink cartridge shown in FIG. 19;

FIG. 21 is an exploded perspective view of the ink cartridge shown in FIG. 19;

FIG. 22 is a cross-sectional side view of the ink cartridge shown in FIG. 19 taken along cross-sectional indicator 22-22 with the push rod in the extended position;

FIG. 23 is a cross-sectional side view of the ink cartridge shown in FIG. 19 taken along cross-sectional indicator 23-23 with the push rod in the retracted position;

FIG. 24 is a cross-sectional side view of the ink cartridge shown in FIG. 19 taken along cross-sectional indicator 24-24 with the push rod in the extended position;

FIG. 25 is a cross-sectional side view of another example ink cartridge having a push rod and a rear foam chamber;

FIG. 26 is a cross-sectional side view of yet another example ink cartridge having a push rod and a rear foam chamber;

FIG. 27 is a schematic bottom perspective view of another example ink cartridge in accordance with inventive principles disclosed herein;

FIGS. 28-33 are schematic front, rear, top, bottom, left side and right side views, respectively, of the ink cartridge shown in FIG. 27;

FIG. 34 is a schematic cross-sectional side view of the ink cartridge shown in FIG. 27 taken along cross-sectional indicators 34-34;

FIG. 35 is a schematic front perspective view of the lid portion of the ink cartridge shown in FIG. 27;

FIG. 36 is a schematic exploded perspective view of the ink cartridge shown in FIG. 27;

FIGS. 37-42 are schematic front, rear, top, bottom, left side and right side views, respectively, of another example ink cartridge in accordance with inventive principles disclosed herein;

FIG. 43 is a schematic cross-sectional side view of the ink cartridge shown in FIG. 36 taken along cross-sectional indicators 43-43; and

FIG. 44 is a front perspective view of the lid portion of the ink cartridge shown in FIG. 37.

While the inventive aspects of the present disclosure are amenable to various modifications and alternate forms, specific embodiments thereof have been shown by way of example in the drawings, and will be described in detail. It should be understood, however, that the intention is not to limit the inventive aspects to the particular embodiments described. On the contrary, the intention is to cover all modifications, equivalents, and alternatives falling within the spirit and scope of the inventive aspects.

### DETAILED DESCRIPTION

The present disclosure relates to replaceable ink containers that provide ink to an ink jet printer. The ink containers includes a housing that defines an ink reservoir, an air vent in air flow communication with the ink reservoir, and an ink outlet in ink flow communication with the ink reservoir. The air vent provides air flow communication with the ink reservoir. The ink outlet provides ink flow communication with the ink reservoir through a leading surface defined by a forward facing vertically oriented wall of the housing. The ink outlet and air vent are typically positioned on different walls of the housing.

As used herein, the terms printer ink cartridge, ink cartridge, printer cartridge, and cartridge generally refer to an ink container configured as an ink cartridge for an ink jet printer. The term “convex” as used herein means a structure that is curved or rounded outward like the exterior of a sphere or circle. The term “concave” as used herein means a structure that is curved or rounded inward like the interior of a sphere or circle. The terms “contour” and “contoured” as used herein mean curved or irregular in shape.

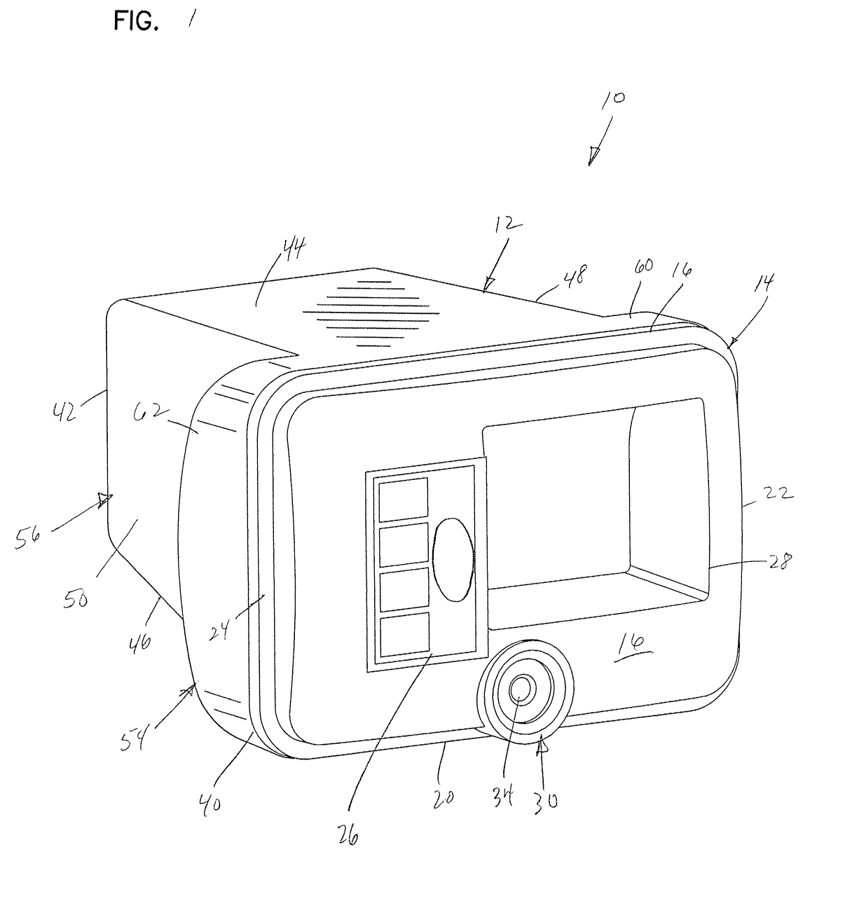

### I. THE EXAMPLE OF FIGS. 1-6

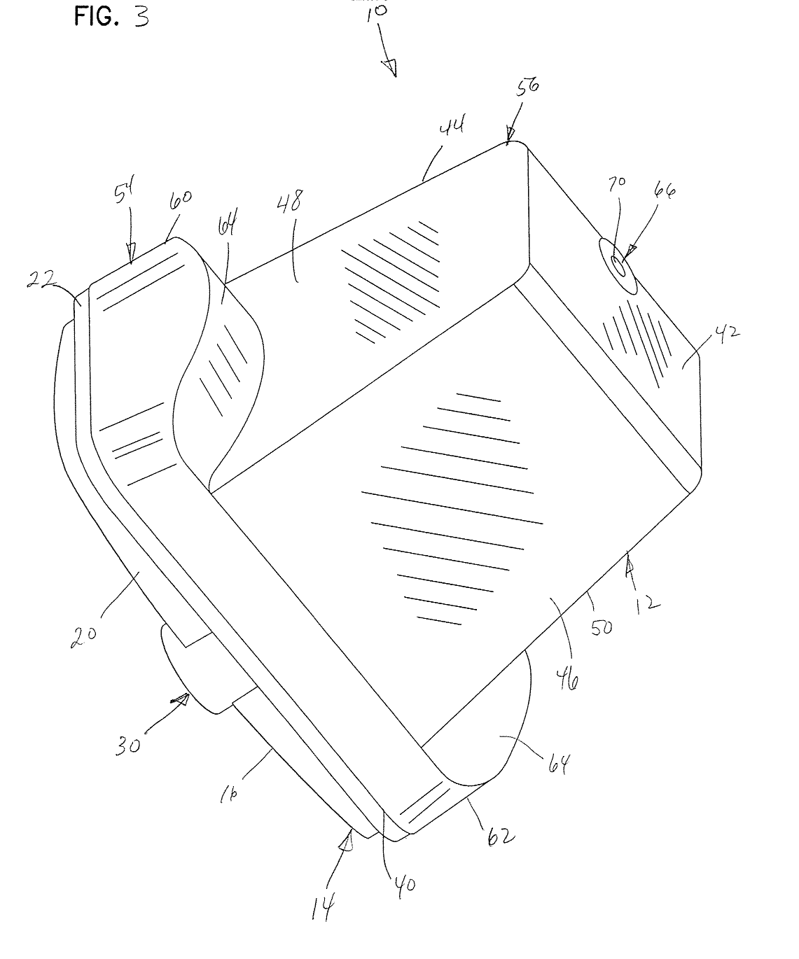

Referring now to FIGS. 1-6, an example ink cartridge 10 is shown and described. Ink cartridge 10 includes a body portion 12 and a lid portion 14. The body 12 and lid 14 are configured to collectively define a bounded volume or ink reservoir 52 (see FIGS. 5 and 6). The body 12 and lid 14 may be formed from a single structural piece. Alternatively the body 12 and lid 14 are structured differently so as to be releasably secured to each other, while in other embodiments the body 12 and lid 14 are secured with a substantially permanent connection. A gasket or other suitable seal can be fit in an interface between body 12 and lid 14. Either or both of the body 12 and lid 14 can include structure that facilitates connection between the two members, such as, for example, a snap fit or interference fit connection. Alternatively, the body 12 and lid 14 can be secured together with a fastener or other connecting device. The body 12 and lid 14 can also be secured together with a permanent connection using, for example, adhesives or welding techniques such as ultrasonic welding, low-frequency welding, or heat welding.

The ink cartridge 10 can be configured to hold a free volume of ink. A free volume of ink refers to a volume of ink that is held within a container without the use of a sponge, foam, ink sack, or intermediate holding structure. A free ink container is substantially open within the internal boundaries of the ink container thus permitting a majority of the enclosed volume to be filled with ink. The ink cartridge 10 is configured to permit a free volume of ink to be extracted from the ink cartridge 10 for delivery to a printer printhead (not shown).

The lid 14 includes a front surface 16, top and bottom sides 18, 19, and first and second opposed sides 22, 24. A rear side 17 (see FIG. 5) is exposed within the ink reservoir 52. The front surface 16 faces away from the ink reservoir 52 in a generally horizontal direction. The front surface 16 can be designed as the forward facing portion of the ink cartridge 10 when the ink cartridge 10 is installed in a printer. The front surface 16 can be referenced as a leading or forward facing surface of the ink cartridge 10. In other embodiments, a different portion of the ink cartridge 10 other than the front surface 16 of the lid 14 can be configured as the leading surface of the ink cartridge 10. Furthermore, the lid 14 can be positioned at a different location on the cartridge 10 in other embodiments, such as the bottom or rear surface, and not define the leading or forward facing surface of the ink cartridge.

The lid 14, in particular the front surface 16, is arranged in a generally vertical oriented plane aligned with vertical axis V_{A} (see FIG. 5) when the ink cartridge 10 is mounted within a printer. The front surface 16 includes at least one recess 28 that permits features of the printer to extend through the front surface 16 into a spaced enclosed by the cartridge 10. The recess 28 can include multiple sections 27, 29 that can have different shapes and sizes (e.g., section 29 has a greater depth than section 27).

The front surface 16 can also include apertures that pass from the outside of the ink cartridge 10 into the ink reservoir 52. One such aperture is shown in FIGS. 1-6 as part of an ink valve assembly 30 that is used for ink flow communication with ink from the ink reservoir 52. The ink valve assembly 30 can also be configured for supplying a volume of ink from outside the ink cartridge 10 into the ink reservoir 52. The ink valve assembly 30 includes an inlet 32, an outlet 34, and a valve structure 36 (see FIG. 5). The outlet 34 is accessible on the front surface 16. The outlet 34 permits an ink removing device of the printer to be inserted through the ink valve assembly 30 and into the ink reservoir 52 as the ink cartridge 10 is mounted into the printer. The valve structure 36 is configured as a self-sealing plug structure. The valve structure 36 may comprise a material such as rubber that is expandable upon insertion of an ink removing device of the printer (not shown), and then retractable to provide a liquid seal that prevents ink from exiting the ink cartridge 10 when the ink removing structure is removed. In other embodiments, ink valve assembly 30 can be replaced with other valve-type structures such as, for example, a spring-loaded ball valve.

Any apertures extending through the front surface 16 of the lid 14 can be located on protruding structures that extend from the front surface 16. The memory device 26 can also be positioned on a structure protruding from the front surface 16. The protrusions through which the apertures extend and on which the memory device 26 is mounted can have leading surfaces arranged in a common vertical plane or arranged in parallel vertical planes. The primary forward facing surface of the lid 14 can have a generally contoured shape or structure. Typically, at least about 10% to about 90% of the surface area of the forward facing surface includes the contoured shape. In some cases, about 30% to about 60% of the surface area of the forward facing surface includes the contoured shape.

The lid 14 can be constructed as a unitary structural piece as shown in FIGS. 1-6, or can comprise a combination of multiple pieces. The lid 14 can be constructed using any known manufacturing process such as molding, extruding, or casting using a material selected for its characteristics of, for example, strength, weight, workability, cost, compatibility with ink, and other considerations. For example, the lid 14 can be injection molded as a single unitary piece from a suitable polymeric material such as, for example, polypropylene (PP), acrilonitrile-butadiene-styrene (ABS), or polystyrene.

A lid 14 constructed as a unitary piece can be fit with auxiliary components. For example, a gasket (not shown) can be used to promote a fluid-tight seal between the body 12 and lid 14. The ink valve assembly 30 can also be positioned on the lid 14 in a separate step, or can be co-molded or otherwise integrally formed with the lid 14. The memory device 26 can be mounted in a separate step to the front surface 16, or may be integrally formed into the lid 14. The memory device 26 can be electrically coupled to other electrical components of the ink cartridge 10.

The use of a contoured front surface 16 can have advantages as compared to generally planar, vertically oriented front surfaces 16. A contoured front surface 16 can improve ease of mounting the ink cartridge 10 in a printer, such as the process of inserting the ink cartridge 10 into an ink cartridge bay of a printer (not shown). Providing a convex contoured shape on the front surface 16 as shown in FIGS. 1-6, wherein the convex shape is curved about a horizontal axis H (see FIG. 4), can reduce interference of the bottom side 20 of the lid 14 with features of the printer.

Other shapes suitable for use on the front surface 16 include, for example, a convex shape that curves about a vertical axis (e.g., along cross-sectional indicator 5-5 in FIG. 4), a concave shape curved about the horizontal axis H or the vertical axis, a hemispherical shape, or a polygonal shape with multiple angled surfaces.

The front surface 16 can include different contoured shapes such as, for example, an inwardly recessed convex shape, or a chamfered or rounded shape along one or more sides of the lid. Further, the contour shape of the front surface 16 can be curved about other axes in addition to the horizontal axis H. Further, in some arrangements the leading surface of at least some of the components positioned on the front surface 16 can also have a contoured shape. For example, the memory chip 26 and portions of the ink valve assembly 30 exposed on the front surface 16 can have a convex contoured shape that matches the shape of front surface 16 shown in FIGS. 1-6.

The body 12 includes front and rear sides 40, 42, top and bottom sides 40, 44, and first and second opposed sides 48, 50. The body 12 includes a shoulder portion 54 near the front side 40, and a rear portion 56 near the rear side 42. The shoulder portion 54 defines first and second shoulders 60, 62. Each of the shoulders 60, 62 defines an engagement surface 64 in the transition area between the shoulder portion 54 and the rear portion 56. As shown in FIG. 6, the maximum width W1 of the shoulder portion 54 is greater than the maximum width W2 of the rear portion 56. The difference in widths W1, W2 partially defines the width W3 of the engagement surfaces 64.

The engagement surfaces 64 resulting from the difference in widths of the shoulder portion 54 and rear portion 56 provides a latching surface for engagement by a latch member of the printer. The latch member of the printer (not shown) includes two latching surfaces that are spaced apart at least the width W2 of the rear portion 56. The two latching surfaces engage the engagement surfaces 64 of the first and second shoulders 60, 62 to hold the ink cartridge 10 in a predetermined mounted position within the printer. A length L1 of the rear portion 56 (see FIG. 6) can be elongated or shortened to provide variations in the volume of the ink reservoir 52 while maintaining the same or similar structure for the shoulder portion 54 for purposes of connecting to a common lid 14. Two or more ink cartridges having different ink capacities resulting from different lengths L1 of the body portion 56 can be alternately installed into the same ink cartridge bay of a printer, thereby providing increased printer configuration flexibility. Using standardized shoulder portion 54 configurations and lid 14 configurations can help reduce manufacturing costs.

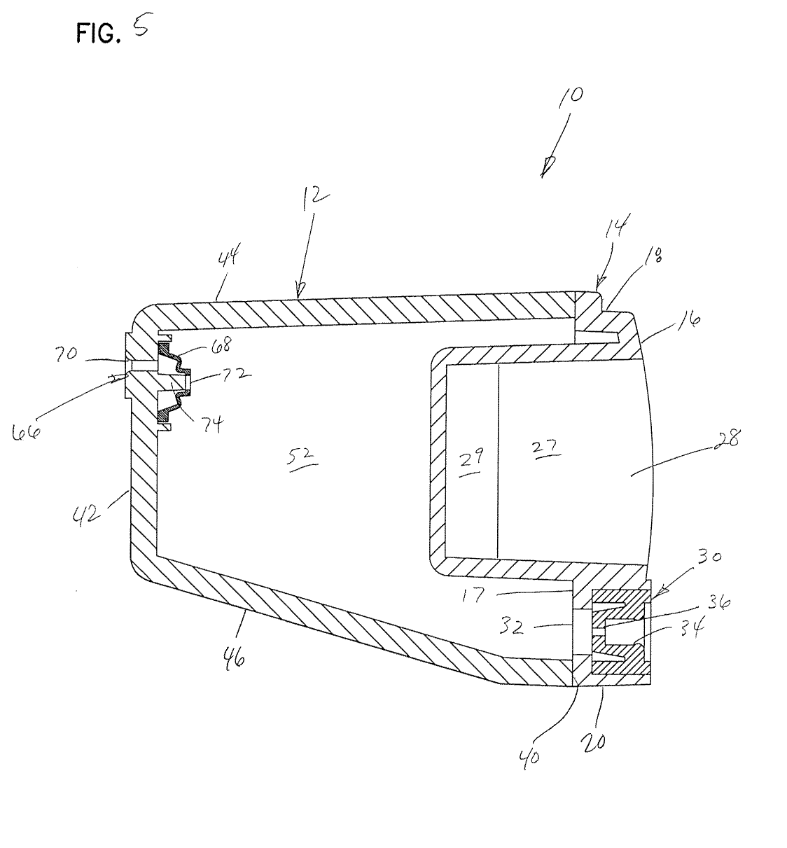

The shoulder portion 54 width W1 is substantially the same as an overall width W4 of the lid 14 (see FIG. 6). The first and second shoulders 60, 62 define a volume that contributes to the overall volume of the ink reservoir 52. In other embodiments (e.g., see FIGS. 9 and 10), the shoulder portions 60, 62 add additional volume to the overall volume of the ink reservoir 52. The body 12 can be configured as a handling portion for a user to grasp and handle the ink cartridge 10. The ink cartridge 10 can be physically held and manipulated for purposes of loading and unloading the ink cartridge 10 from the ink cartridge bay of a printer. The rear portion 56 in particular, with its narrower width W2 at a rear portion of the body 12 may be especially useful for grasping and handling by a user. In some embodiments, the rear portion 56 can have other features that enhance gripping and grasping of the ink cartridge 10. For example, the rear portion 56 may include additional rounded or contoured surfaces, such as convex indents, or groups of parallel elongate protrusions along any of the rear, top, bottom, and first and second sides 42, 44, 46, 48, 50.

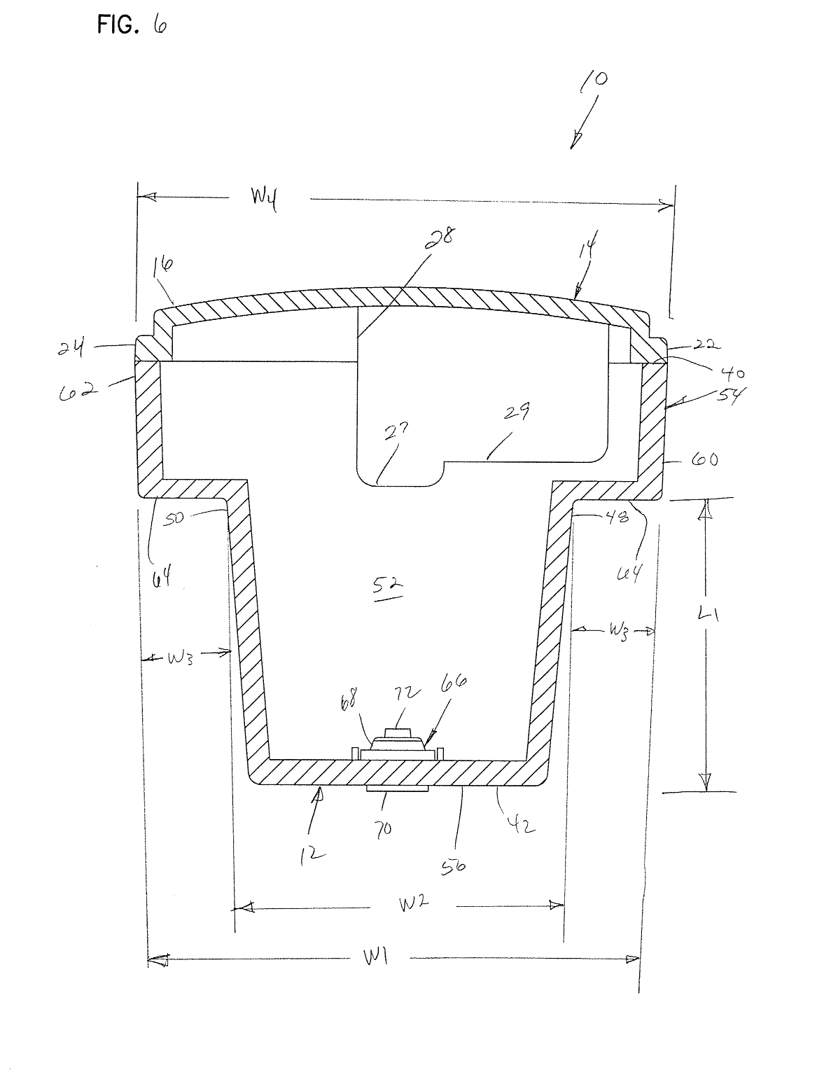

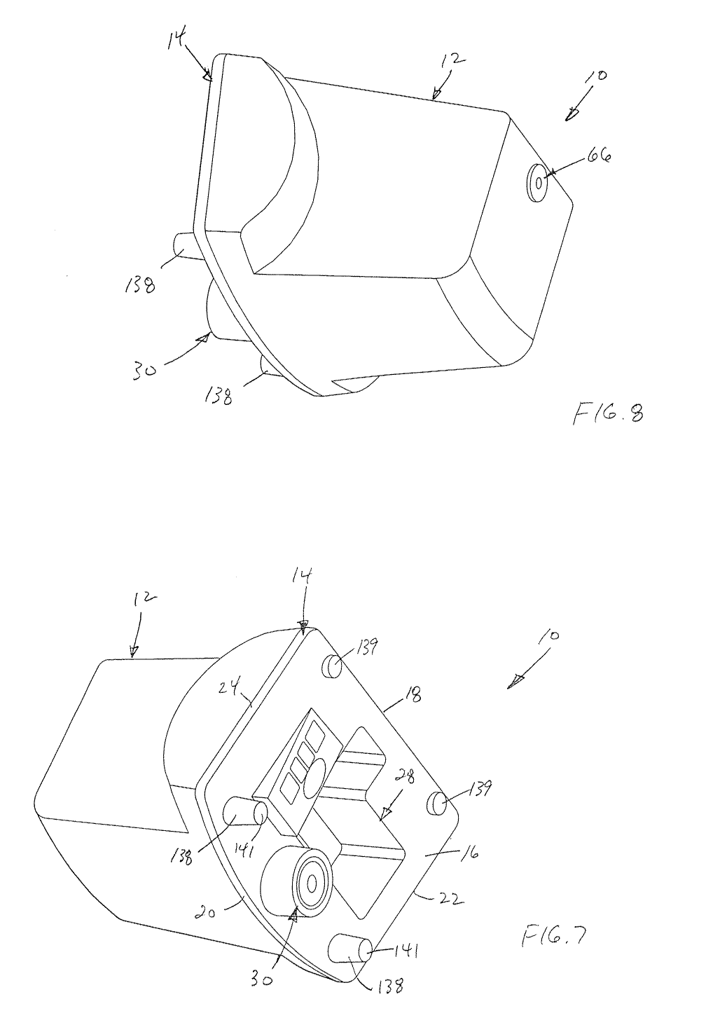

The bottom surface 46 includes an angled or sloped surface to improve easy in mounting the ink cartridge 10 in a printer cartridge bay and engaging a latching member of the printer with the ink cartridge 10. FIG. 5 illustrates the bottom surface 46 having a generally sloped structure from the rear surface side 42 towards the front side 40. The sloped structure of bottom side 46 can reduce interference with features of an ink cartridge bay of the printer. In other embodiments (e.g., ink cartridges 200, 300 shown in FIGS. 11-18), the bottom surface 46 does not include a sloped or angled structure.

The body 12 also includes an air valve assembly 66 positioned along a rear surface 42. The air valve assembly 66 includes a diaphragm 68, an air inlet 70, an air outlet 72, and a sealing post 74. The air valve assembly 66 acts as a one-way valve that permits air to enter into the ink reservoir 52 while prohibiting the outflow of ink or air from within the ink reservoir 52 to outside of the ink cartridge 10. The diaphragm 68 includes the air outlet 72 at a generally central area of the diaphragm 68 that is aligned with the sealing post 74. The diaphragm 68 seals against the sealing post 74 at the air outlet 72 until a vacuum pressure condition is generated within the ink reservoir 52. The vacuum pressure condition typically occurs when ink is drawn out of the ink reservoir 52 through the ink valve assembly 30. When this pressure condition exists, the diaphragm 68 is pulled away from the sealing post thus permitting air to travel through the air inlet 70 and the air outlet 72 into the ink reservoir 52.

In other arrangements the air valve assembly 66 can be positioned on other surfaces of the body 12 or lid 14 besides the rear surface 42. For example, the air valve assembly 66 can be positioned on the top surface 44 of the body 12 or on the front surface 16 of the lid 14. Typically, the air valve assembly is positioned on a surface of the housing different than the surface on which the ink valve assembly 30 is positioned. The diaphragm style one-way valve of the air valve assembly 66 can be modified or replaced with other valve structures. Some alternative valve structures include a spring-biased ball valve, a one-piece rubber valve having a slit that opens under vacuum pressure, and a thin membrane covering a vent opening wherein the thin film is drawn away from the vent opening under vacuum pressure. The one-way valve structure of air valve assembly 66 can be replaced with a two-way valve that opens and closes depending on pressure conditions within the ink reservoir 52 (e.g., see cartridges 400, 500, 600 described below). Further, the ink cartridge 10 can include multiple air valve assemblies each having a one-way or two-way valve function that provide air flow communication with the ink reservoir 52 depending on the pressure condition within the ink reservoir 52.

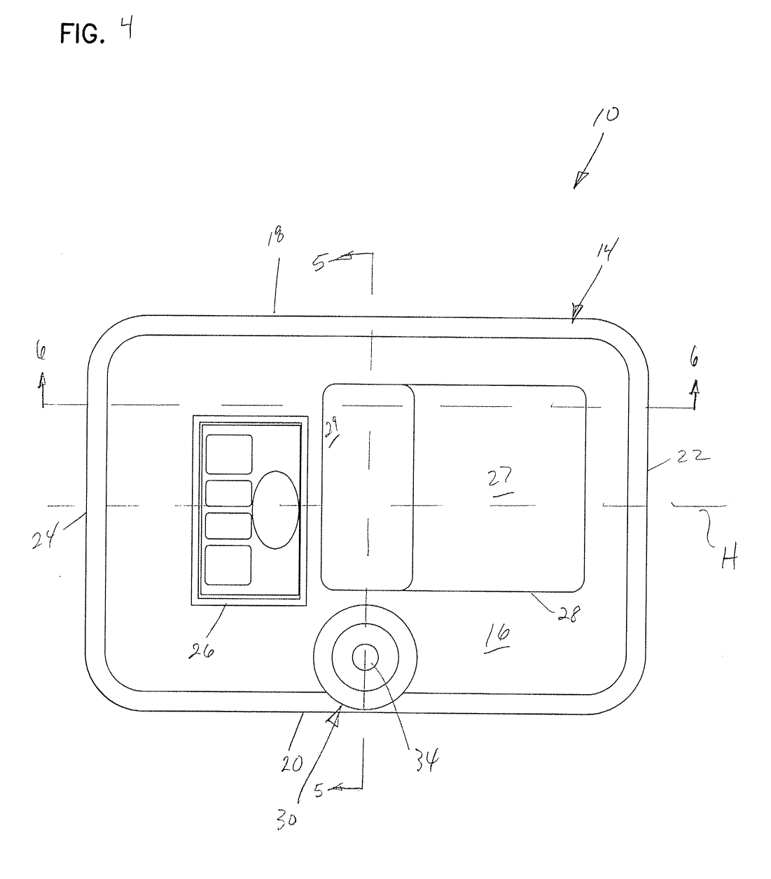

### II. THE EXAMPLE OF FIGS. 7-8

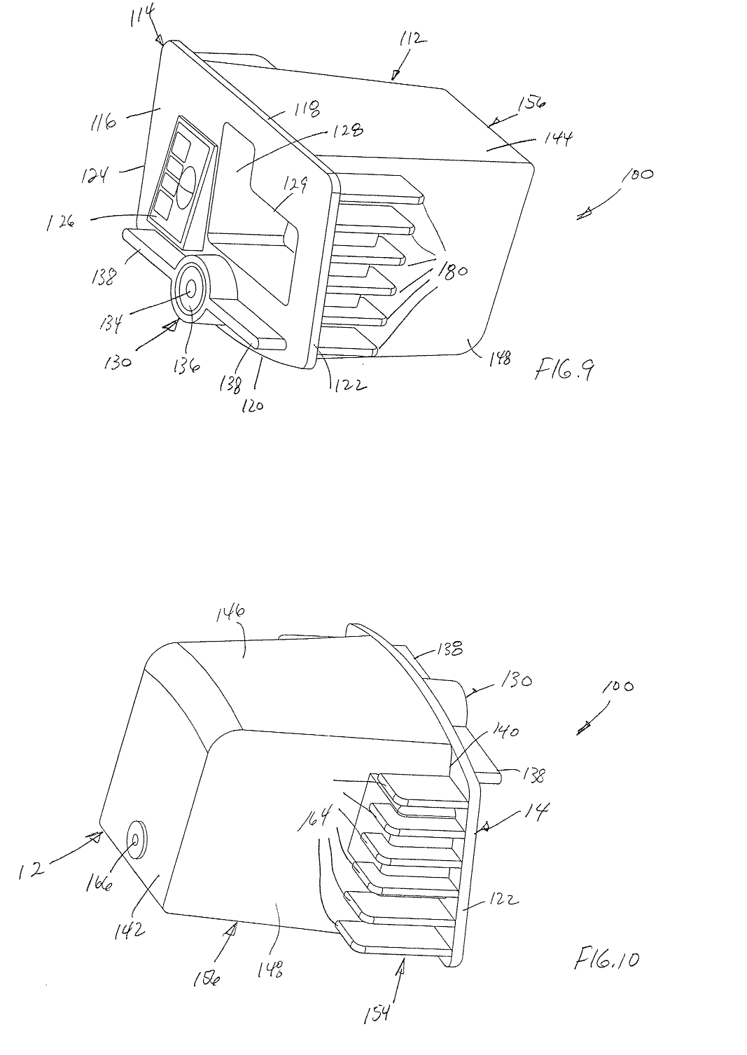

FIGS. 7 and 8 illustrate the ink cartridge 10 including a front surface 16 that is generally planar but that is angled relative to a vertical plane aligned parallel with the vertical axis V_{A} (see FIG. 7). FIGS. 13 and 17 illustrate a similarly oriented angled front surface oriented at an angle β relative to a vertical plane V_{P}. The ink cartridge 10 shown in FIGS. 7 and 8 includes a plurality of stabilizing members 138, 139 near bottom and top sides 20, 18, respectively of the lid 14. Forward facing surfaces 141 of the stabilizing members 138, 139 are arranged in a substantially parallel plane with a front facing surface of the ink valve assembly 30, and parallel with the memory device 26. The stabilizing members 138, 139 as well as the ink valve assembly 30 help to stabilize the ink cartridge 10 while the cartridge 10 is positioned within an ink cartridge bay of a printer. The extent to which the stabilizing members 138, 139, ink valve assembly 30 and memory device 26 extend from the front surface 16 depends in part on the relative angle of the front surface 116 to a vertical plane. In some embodiments, the front surface 16 may be contoured or shaped (e.g., convex, concave, or hemispherical shaped) in addition to being angled relative to the vertical plane. Inclusion of such contoured shapes can influence the size of the stabilizing members 138, 139, ink valve assembly 30, and memory device 26.

The stabilizing members 138, 139 are positioned generally at four corners of the lid 14. In other embodiments, additional or fewer stabilizing members can be used. The stabilizing members can also be positioned at alternative locations on the front surface 116, or can extend from any of sides 118, 120, 122, 124 of the lid 14. Furthermore, the shape and size of the stabilizing members 138, 139 can be changed to vary the extent of the stabilizing function provided by the stabilizing members. Further, the forward most facing surface of the stabilizing members 138, 139 (e.g., surfaces 141 as shown in FIG. 7) can be arranged in a different plane than the forward most surfaces of the ink valve assembly 130 and memory device 26.

### III. THE EXAMPLE OF FIGS. 9-10

FIGS. 9 and 10 illustrate another example ink cartridge 100. The ink cartridge 100 includes a body 112 and a lid 114. The lid 114 includes front, top, bottom and first and second sides 116, 118, 120, 122, 124. A memory device 126 is positioned on the front side 116. A recess 128 and an ink valve assembly 130 are also positioned on the front side 116. The ink valve assembly 130 includes at least an outlet 134 and a valve structure 136. A pair of stabilizing members 138 are positioned adjacent to the ink valve assembly 130 on the front side 116.

The body 112 includes front, rear, top, bottom, and first and second sides 140, 142, 144, 146, 148, 150. The body 112 and lid 114 together define an ink reservoir (not shown) that is configured to hold a volume of ink. The body 112 includes a shoulder portion 154 and a rear portion 156. The shoulder portion 154 includes a plurality of shoulder fins 180 positioned on opposite sides 148, 150. The shoulder fins 180 define an engagement surface 164 along rearward facing surfaces of each of the fins 180 (see FIG. 10). Ink cartridge 100 includes six shoulder fins 180 on each of the first and second sides 148, 150. In other embodiments, more or fewer shoulder fins 180 can be used preferably with at least two fins positioned on each side 140, 150. Further, the dimensions (width, length, height) of the shoulder fins 180 can be altered as to provide different characteristics for the latch engagement surface. One consideration for the size, shape and number of shoulder fins 180 used is the need to provide adequate contact area in the surfaces 164 for engagement by a latching member of the printer (not shown). The position of the shoulder fins 180 can also be changed on the body 112 to optimize contact between the latching member of the printer and the engagement surfaces 164.

The front side 116 of the lid 114 is shown oriented at an angle relative to a vertical plane. FIGS. 13 and 17 illustrate other example angled front sides 116 that are oriented at an angle β relative to a vertical plane V_{P}. The angled orientation of the front side 116 can improve the ease of inserting the ink cartridge 100 into the printer ink cartridge bay.

The front side 116 can include a plurality of protruding components and features that help to stabilize the ink cartridge 100 within the printer ink cartridge bay to compensate for the angled orientation of the front surface 116. For example, the ink valve assembly 130 is shown positioned on a protruding generally cylindrical structure, the memory device 126 is shown positioned on a protruding generally rectangular shaped structure, and the stabilizing members 138 protrude outward from the front side 116 near the bottom side 120. Other protruding members and components can be used to provide a stabilizing function as will be described with reference to the figures described hereinafter.

The recess 128 includes first and second recess portions 127, 129. The portions 127, 129 define a generally L-shaped recess structure. The shape and size of the recess 128 may be altered to customize interface with features of the printer. For example, the size and shape of the portions 127, 129 can be altered to improve or reduce engagement with protruding features of the ink cartridge bay of the printer.

The body 112 includes an air valve assembly 166 positioned on the rear surface 142. The air valve assembly 166 can provide at least a one-way inlet of air into the ink chamber. As described with reference to ink valve assembly 66, the ink valve assembly 166 can be positioned at other sides and surfaces of the ink cartridge 100 such as, for example, the top surface 144 of the body 112 or the front side 116 of the lid 114. Further, the air valve assembly 166 can be configured as a two-way valve. Still further, more than one air valve assemblies can be used to provide airflow communication with the ink reservoir depending on the pressure and other conditions within the ink cartridge.

### IV. THE EXAMPLE OF FIGS. 11-14

FIGS. 11-14 illustrate an ink cartridge 200 having a body 212 and a lid 214. The lid 214 includes a memory device 226, a first recess 28, an ink valve assembly 230, and a second recess 239. The recesses 228, 239 can be sized to receive protruding members of the printer ink cartridge bay. The size and shape of recesses 228, 239 may be configured to avoid engagement with those protruding members of the ink cartridge bay. In some embodiments, the recesses 228, 239 may be sized to provide desired engagement with the protruding members of the ink cartridge bay for aligning or keying functions.

A front surface 216 of the lid 214 is oriented at an angle β relative to a vertical plane V_{P} (see FIG. 13). The structure surrounding the second recess 239 and the protrusion housing the ink valve assembly 230 extend in a forward direction from the front surface 216 and have forward most facing surfaces that are aligned generally within a plane parallel to the vertical plane V_{P}. The memory device 226 is shown recessed rearward of the forward most surfaces of the ink valve assembly 230.

The body 212 includes rear, top, and bottom sides 242, 244, 246. The body 212 also includes a shoulder portion 254 having first and second shoulders 260, 262, and a rear portion 256. Engagement surfaces 264 are defined on the surface defined between the shoulders 260, 262 and the rear portion 256. The engagement surfaces 264 are configured for engagement by latching members of the printer such as a latching structure of the ink cartridge bay of a printer (not shown). As shown in FIG. 13, the engagement surfaces 264 are arranged in a non-parallel orientation relative to the angled front surface 216 of the lid 214. The engagement surfaces 264 are arranged in a generally perpendicular arrangement relative to the top surface 244 and bottom surface 246. Further, the engagement surfaces 264 are arranged generally parallel to the rear surface 242 of the body 212. In other embodiments, the engagement surfaces can be arranged in a non-parallel orientation relative to rear surface 242 and an orientation non-perpendicular to the top and bottom surfaces 244, 246.

The body 212 further includes an air valve assembly 266 positioned along the top side 244. Air valve assembly 266 includes a diaphragm 268, an air inlet 270, and an air outlet 272. The air valve assembly 266 can be configured as a one-way valve that permits air to enter into the ink reservoir 252 upon generation of a vacuum pressure condition within the ink reservoir 252. The air valve assembly 266 can have other configurations in other embodiments. For example, the valve assembly 766 can be a two-way valve. Further, the air valve assembly 266 can be positioned on other sides of the body 212, or surfaces of the lid 214.

### V. THE EXAMPLE OF FIGS. 15-18

FIGS. 15-18 illustrate an ink cartridge 300 that includes a body 312 and a lid 314. The lid 314 includes a front surface 316, top and bottom sides 318, 320, and first and second opposed sides 322, 324. A memory device 326 is positioned on the front surface 316 adjacent to a recess 328, an ink valve assembly 330, and an air valve assembly 366. The front surface 316 is angled relative to a vertical plane V_{P} at an angle β. The front surface 316 is angled rearward from the top side 318 to the bottom side 320. In other arrangements, the front surface can be angled in different directions such as from side 322 to side 324, or from bottom side 320 rearward to top side 218.

The ink valve assembly 330 and air valve assembly 366 include protruding structures that extend forward from the front surface 316. The protruding structures of the ink valve assembly 330, air valve assembly 366, and memory device 326 can act as stabilizing members that help to stabilize the ink cartridge when mounted within the printer (e.g., within an ink cartridge bay of the printer). The forward most facing surface of at least the ink valve assembly 330 and air valve assembly 366 are aligned within a generally vertical plane parallel with plane V_{P}.

The size and shape of recess 328 may be suitable to receive a protruding structure of the printer. The recess 328 may be sized to avoid engagement with such protruding structures. Alternatively, the recess 328 can be configured to engage alignment and keying protruding structures of the printer.

The body 312 includes rear, top, bottom and first and second sides 342, 344, 346, 348, 350. The body 312 also includes a shoulder portion 354 having first and second shoulders 360, 362, and a rear portion 356. The connecting surface between the shoulders 360, 362 and the rear portion 356 defines an engagement surface 364 configured for engagement by a latching member of the printer (not shown). The latching member engages the engagement surfaces 364 to hold the ink cartridge 300 within the printer. The engagement surfaces 364 are aligned in a generally non-parallel orientation with the front surface 316 of the lid 314. The engagement surfaces 364 are arranged generally perpendicular to the top and bottom sides 344, 346, and in a generally parallel arrangement with the rear surface 342. In other embodiments, the engagement surface 364 can be sized and oriented at different angles relative to the top, bottom and rear surfaces 344, 346, 342, and the front surface 316.

The body 312 further includes a protruding structure 382 extending from the bottom side 346. The protrusion 382 can include an internal recess that is in fluid communication with an ink reservoir 352 defined within the ink cartridge 300. The size and shape of protrusion 382 can be altered as desired for the purpose of, for example, increasing or decreasing the volume of the ink reservoir 352.

The ink valve assembly 330 and air valve assembly 366 are aligned along a vertical axis within a vertical plane. The structure of the valves in the ink valve assembly 330 and air valve assembly 366 are self-sealing plug-type valves. In other embodiments, the valves 330, 366 can have different valve structures such as, for example, a spring-loaded ball valve. Further, the valves 330, 366 can be configured as two-way or one-way valves. One or more of the valves 330, 366 can be replaced with a stop plug structure that requires manually removing the stop plug prior to inserting the cartridge 300 into the printer and replacing the plug to seal the ink cartridge upon removing the ink cartridge 300 from the printer. Additional air and ink valves can be included on the ink cartridge 300 to supplement the valves 330, 366.

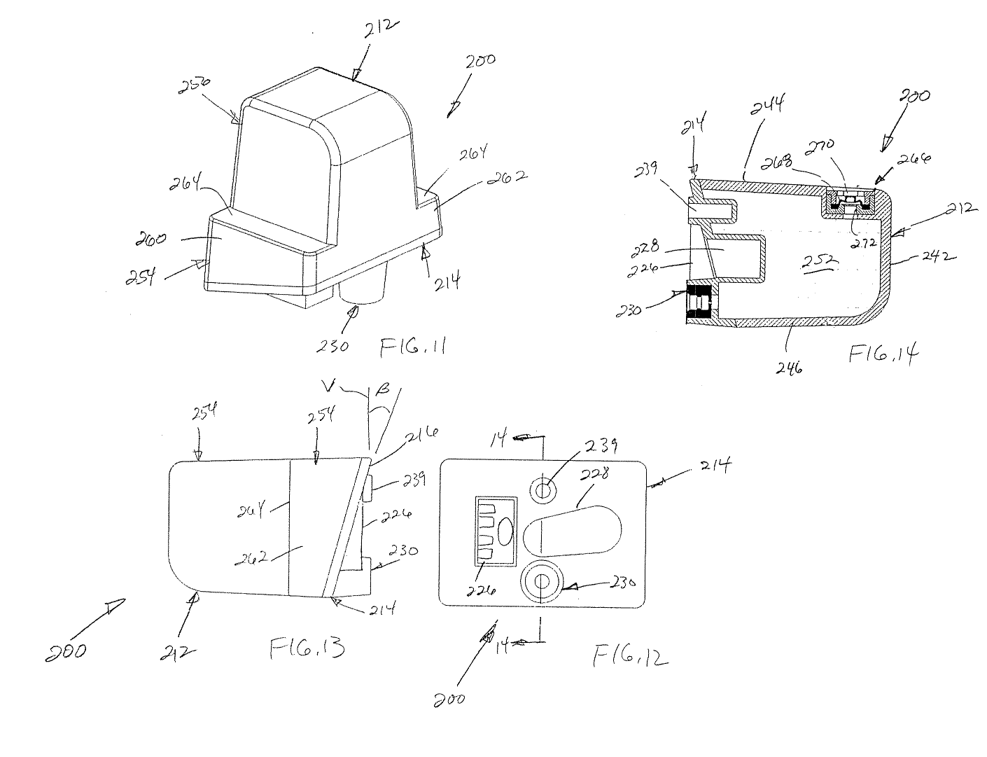

### VI. THE EXAMPLES OF FIGS. 19-26

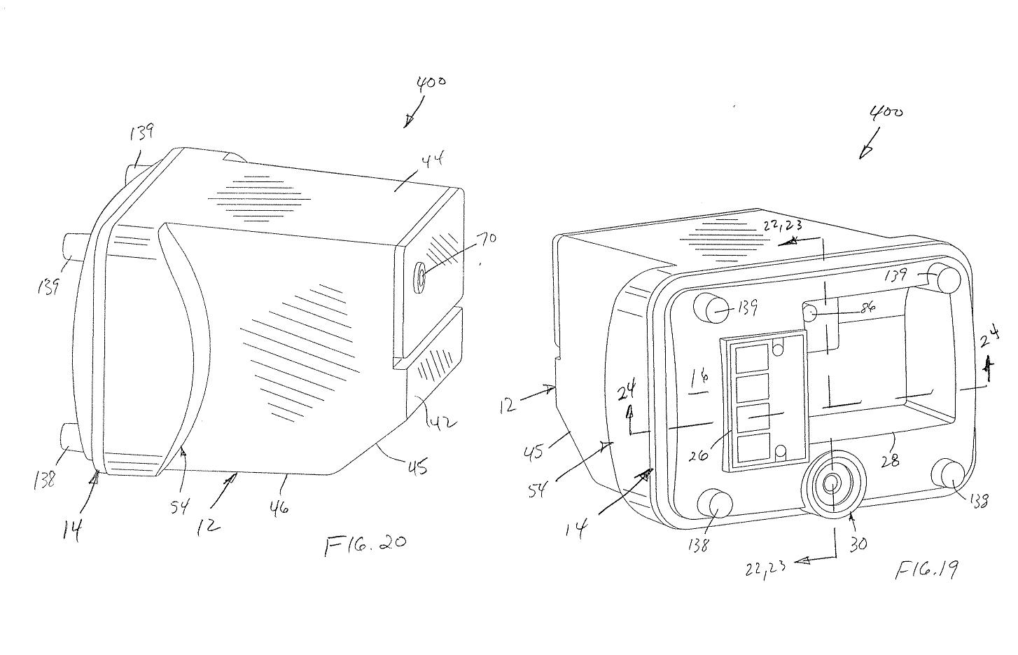

FIGS. 19 and 24 illustrate an ink cartridge 400 that includes a two-way valve arrangement for air flow communication into an out of an ink reservoir of the cartridge 400. The ink cartridge 400 includes a body 12 and lid 14 having many of the same or similar features included in ink cartridge 10 illustrated in FIGS. 1-8. The body 12 includes top and bottom surfaces 44, 46 that are arranged substantially parallel with each other. A rear surface 42 is arranged substantially perpendicular to the top and bottom surfaces 44, 46. An angled or chamfered surface 45 extends between the rear surface 42 and the bottom surface 46. The angled surface 45 can improve insertability of the ink cartridge 400 into an ink cartridge bay of a printer (not shown). The angled surface 45 can also permit a latching member of the ink cartridge bay to more easily engage portions of the ink cartridge 400 to hold the ink cartridge 400 within the ink cartridge bay.

The lid 14 has a generally curved shaped forward facing surface between the top and bottom sides of the cartridge 400. The curved shaped shown in FIGS. 19-24 is generally concave and curves about a horizontal axis extending across a width of the cartridge 400. A recess 28 is defined in a front surface 16 of the lid. A memory device 26 is mounted on the front surface 16 adjacent to the recess 28. An ink valve assembly 30 is also positioned on the front surface 16. The ink valve assembly 30 provides ink flow communication with the ink reservoir 52 of the ink cartridge 400. A plurality of stabilizing members 138, 139 extend forward from the front surface 16. The stabilizing members 138, 139 each include a leading surface that helps define a leading surface of the ink cartridge 400 as the cartridge is inserted into the ink cartridge bay.

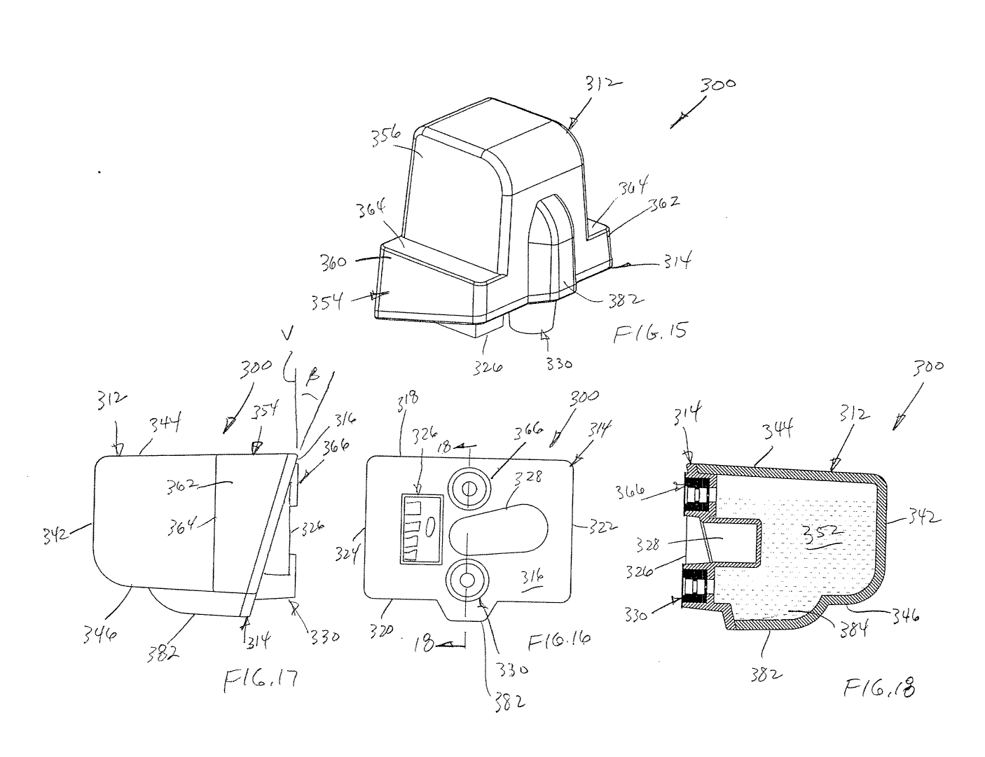

Referring now to FIG. 21, the ink cartridge 400 includes a two-way air valve arrangement that provides air flow communication with the ink reservoir 52. The air valve arrangement includes a spring chamber 93, first and second foam chambers 94, 95, and a spacer chamber 96 defined in the body 12, and a front air passage 99 at a front end of the spring chamber 93 (see FIGS. 22 and 23). A rod aperture 98 is defined in the lid 14 in alignment with the front air passage 99 and exposed within the recess 28 of the lid 14 (see FIGS. 22 and 23).

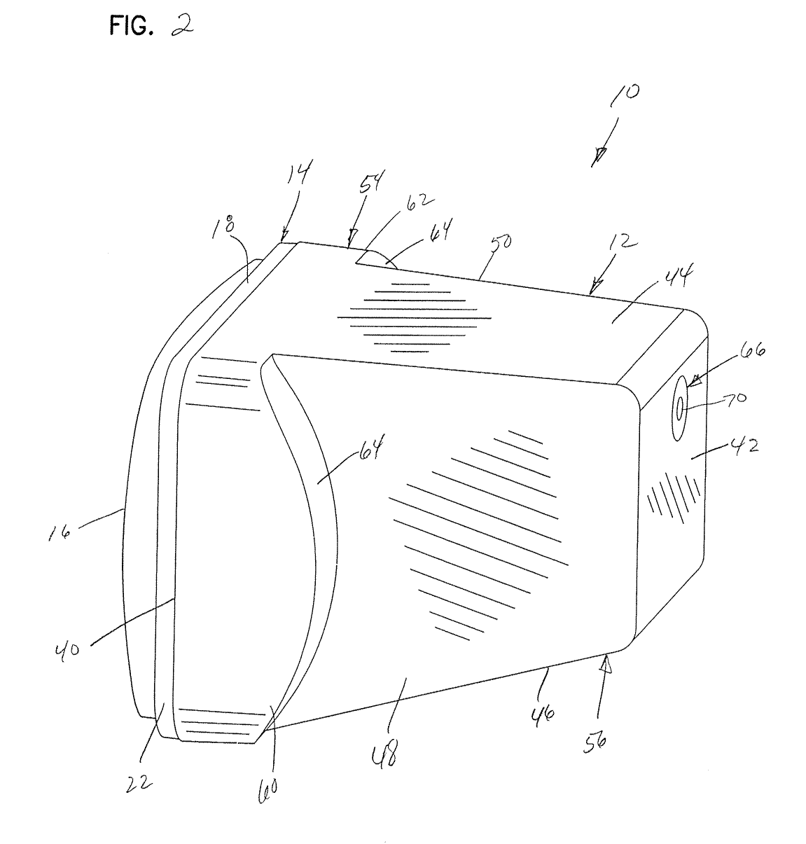

The air valve arrangement further includes an end cap 81, a spring plate 82, a spring 83, an actuator 84, a push rod 85 having a channel 86, a washer 87, and a sealing member 88. The spring plate 82 is sized to fit within the spring chamber 93 with, for example, an interference fit, to retain the spring 83 and actuator 84 within the spring chamber 93. The washer 87 and sealing member 88 are positioned on the push rod 85 and mounted to the lid 14 (see FIGS. 22 and 23). The push rod 85 extends through the rod aperture 98, the ink reservoir 52, and through the front air passage 99 into engagement with the actuator 84 (see FIG. 22). When the rod is moved in a direction toward the rear surface 42 of the body 12 (e.g., from the position shown in FIG. 2 to the position shown in FIG. 23) the push rod 85 moves the actuator 84 against biasing forces of the spring 83. In the rest stage shown in FIG. 22, the actuator 84 engages a front end of the spring passage 93 surrounding an opening into the front air passage 99 to seal off air flow communication between the spring chamber 93 and the ink reservoir 52. When the actuator 84 is moved rearward under forces applied by the push rod 85 as shown in FIG. 23, air flow communication occurs between the spring chamber 93, through the front air passage 99 and the channel 86 of the push rod, and into the ink reservoir 52.

The rod aperture 98 in combination with the push rod 85, washer 87 and sealing member 88 prevent air flow through the rod aperture 98. The ink cartridge 400 includes no other air port, air vent, or means of communicating air from outside the ink cartridge through the lid 14, in particular through the front surface 16 of the lid 14, or from the ink reservoir 52 out of the ink cartridge 400 through the lid 14 or the front surface 16 of the lid 14. The ink cartridge 400 is sealed from all fluid communication between outside the ink cartridge and the ink reservoir except for ink flow communication intended to occur through the ink valve assembly 30.

The spring chamber 93 is surrounded on three sides (opposing left and right sides and bottom side) with portions of the ink reservoir that are in open fluid communication with each other. When the end cap 81 is secured to the rear surface 42 of the body 12, the spring chamber 93 is sealed from fluid communication with the first and second foam chambers 94, 95 and spacer chamber 96 except through the top air passage 97 (see FIGS. 21-23). An air port 70 is positioned on the end cap 81 to provide air flow communication with ambient air outside the ink cartridge 400 and the spring chamber 93 along an air flow path 79 shown in FIG. 24. The air flow path 79 is a bi-directional flow path between the spring chamber 93, through the top air passage 97, underneath the spring chamber 93 through the first and second foam chambers 94, 95 and spacer chamber 96, and out of the air opening 70. The air flow path 79 is further defined by insertion of a spacer 89 within the spacer chamber 96. The spacer 89 includes a tapered end 89A (see FIGS. 21-22 that defines a bottom air passage 92 extending between the first and second foam chambers 94, 95.

The first and second foam chambers 94, 95 can receive first and second foam members 90, 91. The foam members 90, 91 are configured to absorb ink that may inadvertently enter spring chamber 93 and pass into the foam chambers 94, 95 through the top air passage 97. The foam members 90, 91 are also configured to allow air to travel through the foam chambers 94, 95 between the air opening 70 and top air passage 97 through the bottom air passage 92.

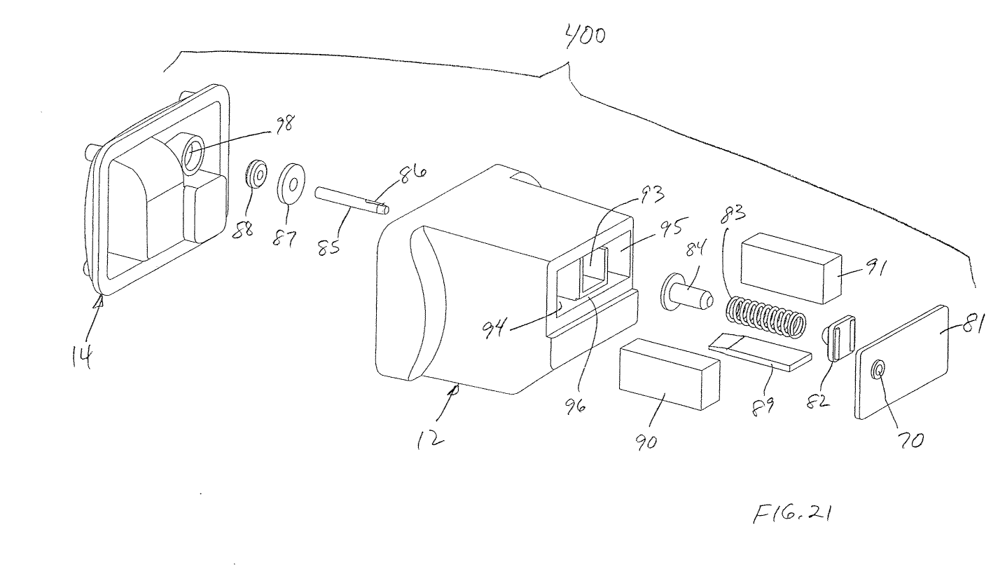

While a specific air valve arrangement has shown and described with reference to FIGS. 19-24, many other arrangements including different features and constructions may be used to provide the same or similar function. For example, referring to FIGS. 25 and 26, a simplified two-way air valve arrangement is shown and described. FIG. 25 illustrates an ink cartridge 500 wherein the spring chamber, one of the foam chambers, and the spacer chamber are replaced with a single foam chamber rearward of the push rod 85. A moveable membrane 78 is positioned over the front air passage 99 within the foam chamber 94. A foam member 90 positioned within the foam chamber 94 absorbs any ink that may pass from the ink reservoir 52 into the foam chamber 94, while still permitting air flow communication from the air opening 70 and through the front air passage 99 into the ink reservoir 54 when the movable membrane 78 is in an open position. The movable membrane 78 moves to an open position when the rod 85 is moved rearward thereby pushing the movable membrane 78 away from the front air passage 99. A channel 86 in the rear end of the push rod 85 provides air flow communication from the foam chamber 94 into the ink reservoir 52 when the movable membrane 78 is moved into the non-engaged position upon the rearward engagement by the push rod 85. The foam member 90 provides a biasing force that forces the movable member 78 back into the sealed position around front air passage 99 upon removal of the axial force used to move the push rod 85 in a rearward direction into engagement with the membrane 78.

The ink cartridge 600 illustrated in FIG. 26 includes many of the same components and functions in a similar way to the ink cartridge 500 described above with reference to FIG. 25. The body 12 of the ink cartridge 60 further includes a generally sloped bottom surface 46.

Ink cartridges 500, 600 provide sealing of a rod aperture 98 within a wall of the lid 14 so as to prevent air flow communication from within the ink reservoir 52 through the lid 14 to ambient air outside of the cartridges 500, 600. The only fluid communication between outside the cartridges 500, 600 and the ink reservoir 52 occurs through the two-way valve arrangement (including the air opening 70, foam chamber 94, front air passage 99, and channel 86 when the rod 85 is moved rearward), and the ink valve assembly 30.

The two-way airway valve assemblies shown in FIGS. 19-26 can function automatically to maintain ambient air pressure conditions within the ink reservoir 52 when the cartridges 400, 500, 600 are mounted within a cartridge bay of a printer and the push rod 85 is moved rearward to provide air flow communication between an ink reservoir 52 and an air outlet 70. For example, if ink is inserted into or drawn out of the ink reservoir 52 through the ink valve assembly 30, air will flow through the two-way air valve arrangement as needed to balance the air pressure back to ambient air pressure condition within the ink reservoir 52.

As described above, the air opening 70 can be positioned at any desired location on the ink cartridge body 12. For example, the air opening 70 can be positioned along the top surface, opposing side surfaces, or bottom surface of the body 12. In some arrangements, the air inlet can be positioned along a front surface of the body 12, or through the lid 14. Preferably, the air opening 70 is positioned within an upper portion of the ink cartridge (e.g., above a horizontal plane passing through a centerline of the cartridge). In one example, the air opening 70 is positioned vertically above the rod aperture 98 in the lid 14 when the cartridge is arranged with the front surface 16 facing in a generally horizontal direction. In another example, the end cap 81 can be positioned along a top surface of the body 12 rather than along the rear surface 42, and the air opening 70 positioned in the end cap 81 is therefore positioned along the top surface of the body 12.

Other features of the two-way air valve arrangement can be altered, removed, or added in order to provide the desired two-way air valving function while minimizing the likelihood of ink exiting the ink reservoir 52 through the air outlet 70. In one example, the spring plate 82 is eliminated and the spring 83 directly engages the end cap 81. In another example, the actuator 84 includes only a disk-shaped structure without the extension shown in FIG. 1 that extends into a center of the spring 83. In a yet further arrangement, the spring 83 is replaced with a different biasing member such as, for example, a piece of foam or other porous structure that permits air flow while providing a biasing force against the actuator 84. In still further arrangements, the spring 83 and actuator 84 can be a single unitary piece that provides sealing and biasing functions concurrently.

The spacer 89 can also be modified in a number of ways. For example, the first and second foam members 90, 91 and spacer 89 may be configured as a single unitary piece. The spacer 89 can also comprise different materials such as ink absorbing materials or non-ink absorbing materials. The taper 89A on the spacer 89 can be replaced with a channel or other feature that results in a bottom air passage 92 being defined between the first and second foam chambers 94, 95 when the spacer 89 is positioned within the spacer chamber 96.

In a further arrangement, the spring 83 can be positioned along the rod 85 and within the ink reservoir 52. In such an arrangement, the sealing structure of the actuator 84 can be integrated into a rear end of the rod 85 within the spring chamber 93, wherein the biasing member 83 biases the push rod 85 into a position in which the front air passage 99 is maintained closed or sealed closed until the push rod 85 is moved rearward by an external force.

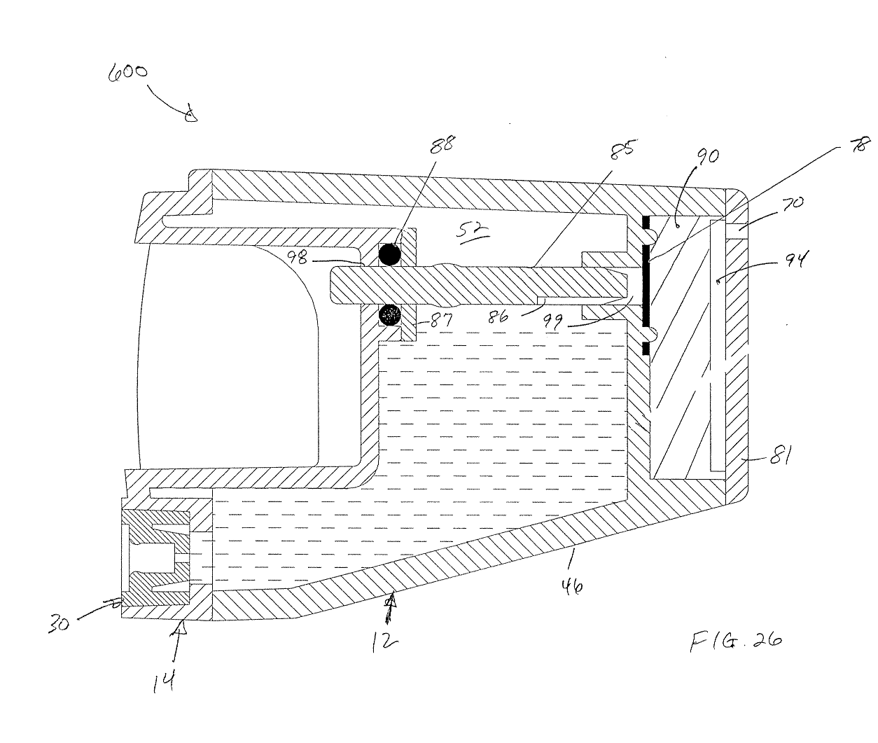

### VII. THE EXAMPLES OF FIGS. 27-36

Another example ink cartridge 700 is now described with reference to FIGS. 27-36. Cartridge 700 includes many of the same or similar features as ink cartridge 10 described above. Cartridge 700 further includes both the ink valve assembly 30 and an air valve assembly 66 positioned on the lid 14. The air valve assembly 66 extends from a rear surface of the second portion 29 of the front recess 28 in a forward facing direction (see FIG. 34). The air valve assembly 66 is shown recessed from the front surface 16 in this example, but can be positioned at the front surface 16 in other examples.

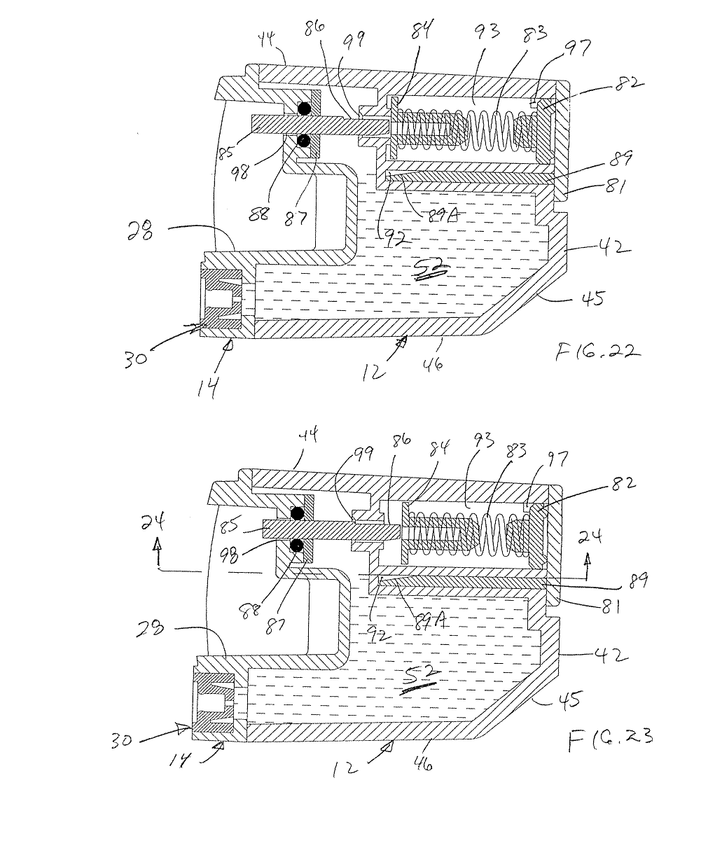

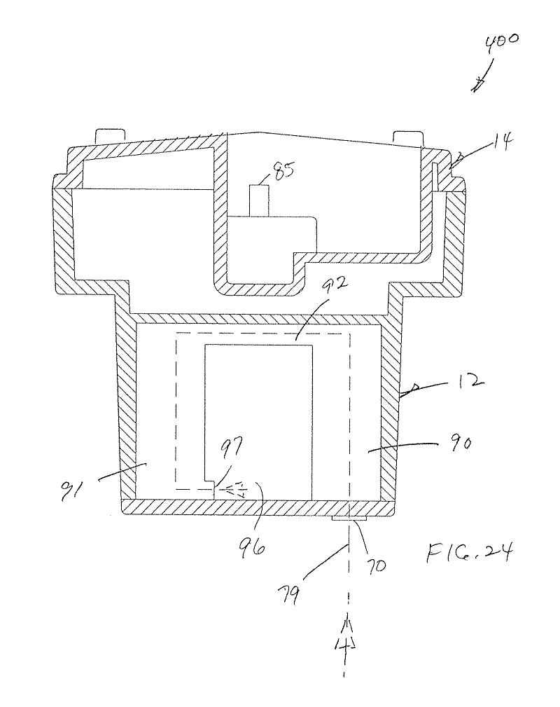

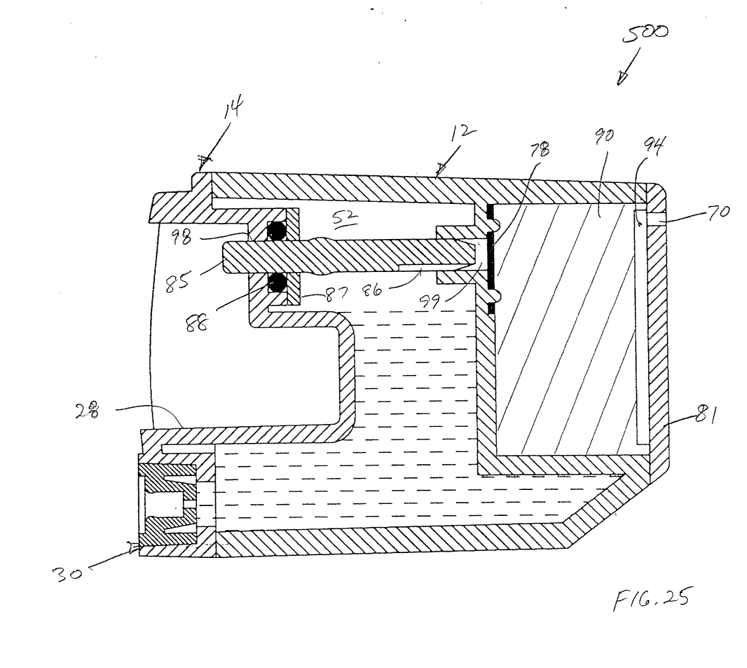

The lid 14 includes a slanted or undercut surface 17 that extends from the front surface 16 to the bottom side 20. The ink valve assembly 30 is positioned on the slanted surface 17 and oriented in a forward facing direction (see FIG. 28). In other arrangements, the ink valve assembly 30 can be recesses rearward from the front surface 16 and slanted surface 17. The front surface 16 has a generally contoured convex shape.

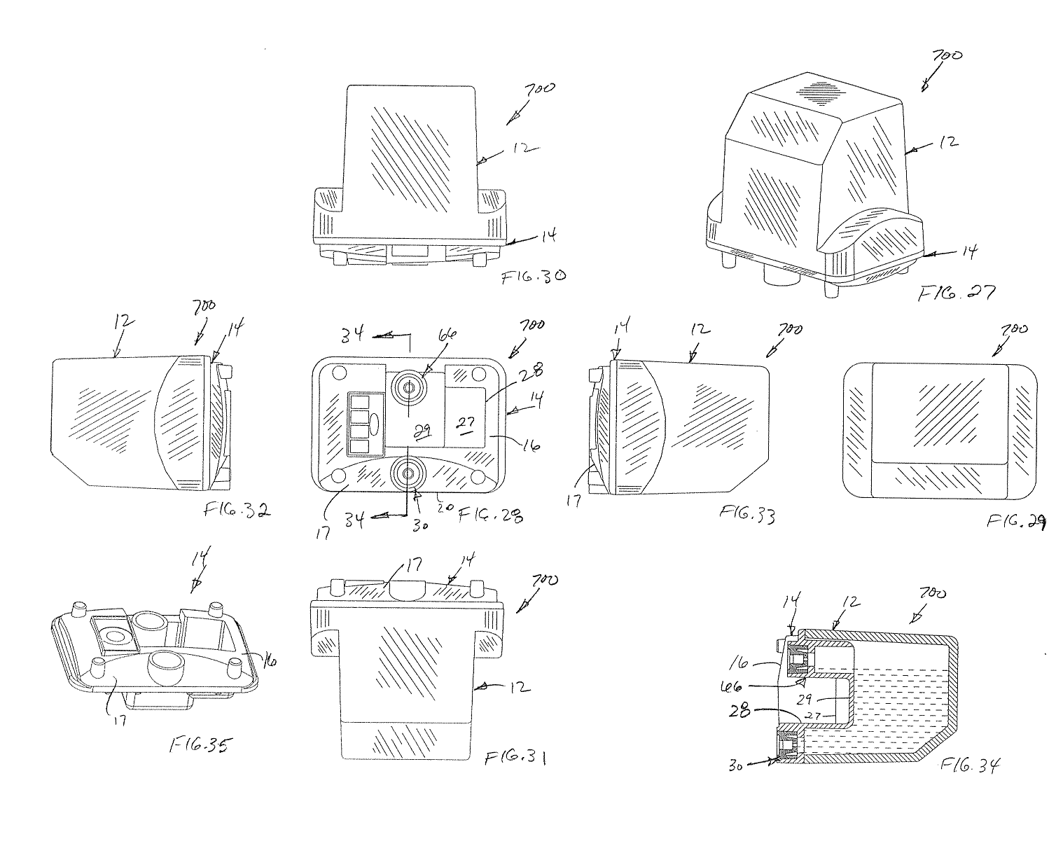

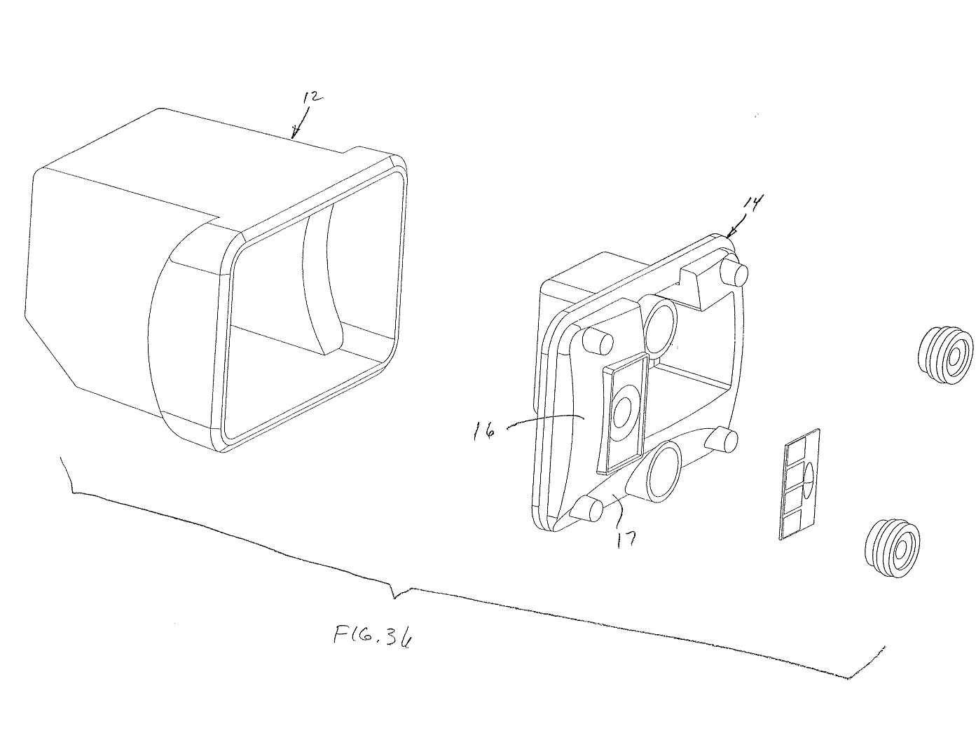

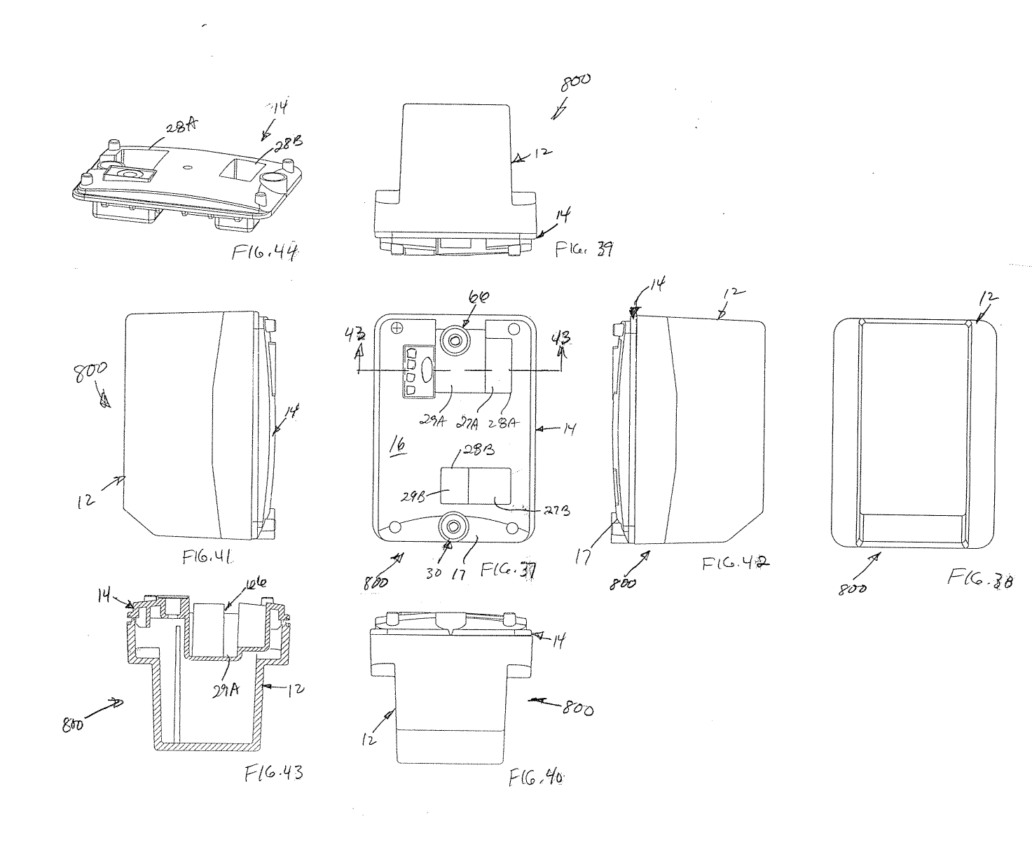

### VIII. THE EXAMPLES OF FIGS. 37-44

A further example ink cartridge 800 is shown with reference to FIG. 37-44. The cartridge 800 has an enlarged capacity body 12 as compared to the example described above with reference to FIG. 1-36. The cartridge 12 includes two recesses 28A, 28B that are arranged in vertical alignment with each other on the front surface 16. The recesses 28A, 28B have first and second portions 27A, 29A and 27B, 29B, respectively. The air valve assembly 66 extends from the second recess portion 29A and is recessed from the front surface 16 (see FIG. 43). At least a portion of an ink valve assembly 30 extends from a slanted surface 17 defined near the bottom side 20 of the lid 14. While two separate recesses 28A, 28B are shown in this example, other arrangements can include a single recess that connects the recesses 28A, 28B together.

### IX. SUMMARY AND CONCLUSION

One aspect of the present disclosure relates to an ink cartridge that includes a housing and an ink outlet. The housing defines an ink reservoir and includes a leading surface oriented in a generally vertical plane. The leading surface has a contoured shape. The contoured shape can be a convex shape. The ink outlet is coupled in fluid communication with the ink reservoir and is positioned on the leading surface. The ink cartridge can further include an air inlet into the ink reservoir. The air inlet is positioned on a surface of the housing different from the leading surface.

Another aspect of the present disclosure relates to a printer ink cartridge that includes a housing and an ink outlet. The housing defines an ink reservoir containing ink. The housing also includes a leading surface and at least one latching surface. The latching surface includes a contoured structure that is arranged facing in a direction generally opposite the leading surface. The ink outlet is positioned on the leading surface. The ink cartridge can further include an air vent. The air vent can be positioned on a surface of the housing different from the leading surface and in fluid communication with the ink reservoir. The air vent can also be positioned facing in the same direction as the ink outlet, but recessed from the leading surface. Other arrangements the air vent and ink outlet relative to each other and the leading surface are possible.

A still further aspect of the present disclosure relates to an ink cartridge that includes a housing, and ink outlet, and an air valve arrangement. The housing defines an ink reservoir containing ink. The housing also has a leading surface facing in a generally horizontal direction on a front side of the housing. The ink outlet is positioned on the leading surface. The air valve arrangement includes an air vent. The air valve arrangement can be actuatable from the front side of the housing to create air flow communication between the ink reservoir and the air vent. The air vent can be positioned on a side of the housing different from the front side.

Another aspect of the present disclosure relates to a method of filling an ink cartridge. The ink cartridge includes a body portion and a lid portion. The lid portion defines a contoured leading surface of the ink cartridge. The body portion can include a contoured shaped latching surface. The cartridge can further include an ink outlet and an air vent arrangement. The ink outlet and air vent arrangement can be accessible from the same surface of the cartridge (e.g., the leading surface). An air vent of the air vent arrangement can be positioned on a surface of the cartridge that is different from the surface upon which the ink outlet is positioned. The method steps include filling the body portion with ink, and securing the lid portion to the body portion to seal the ink within the ink cartridge.

The above specification provides examples of how certain inventive aspects may be put into practice. It will be appreciated that the inventive aspects can be practiced in other ways than those specifically shown without departing from the spirit and scope of the inventive aspects.

We claim:

1. An ink cartridge, comprising:
a housing defining an ink reservoir, the housing including a leading surface oriented in a generally vertical plane, the leading surface having a contoured shape; and
an ink outlet from the ink reservoir positioned on the leading surface.

2. The ink cartridge of claim 1, further comprising an air inlet into the ink reservoir, the air inlet positioned on a surface of the housing different from the leading surface.

3. The ink cartridge of claim 1, further comprising a memory device positioned on the leading surface.

4. The ink cartridge of claim 1, wherein the contoured shape is a convex shaped curved about a generally horizontal oriented axis.

5. The ink cartridge of claim 2, wherein the air inlet is positioned on a rear surface of the housing that faces in a direction opposite to the leading surface.

6. The ink cartridge of claim 1, wherein the housing includes a lid member and a body member, wherein the lid member defines the leading surface.

7. The ink cartridge of claim 6, wherein the body member defines at least one latching surface, the at least one latching surface including a contoured shape.

8. The ink cartridge of claim 7, wherein contoured shape is a convex shape curved in a direction opposite to a curvature of the leading surface.

9. The ink cartridge of claim 1, further comprising an air vent arrangement, the air vent arrangement providing air flow communication with the ink reservoir, the air vent arrangement configured for actuation into an open position from the leading surface and air flow communication through a side of the housing different from a side of the housing that does not include the leading surface.

10. The ink cartridge of claim 9, wherein the air vent arrangement includes a push rod exposed at the leading surface side of the housing, the push rod arranged to open an air channel between the ink reservoir and a space outside of the ink cartridge upon movement of the push rod rearward relative to the front surface.

11. A printer ink cartridge, comprising:
a housing defining an ink reservoir containing ink, the housing having a leading surface and at least one latching surface, the latching surface including a contoured structure and arranged facing in a direction generally opposite the leading surface; and
an ink outlet positioned on the leading surface.

12. The ink cartridge of claim 11, further comprising an air vent positioned on a surface of the housing different from the leading surface and in fluid communication with the ink reservoir.

13. The ink cartridge of claim 11, wherein the leading surface includes a contoured structure.

14. The ink cartridge of claim 1, wherein the contoured structure includes a convex shape.

15. The ink cartridge of claim 11, wherein the leading surface includes a contoured structure that curves in a direction different from a direction of curvature of the latching surface contoured structure.

16. The ink cartridge of claim 15, further comprising a memory device positioned on the leading surface.

17. The ink cartridge of claim 11, wherein the leading surface and the latching surface are oriented generally vertically oriented plane.

18. The ink cartridge of claim 12, further comprising an air valve arrangement that include the air vent and is configured for actuation from a side of the housing that includes the leading surface.

19. An ink cartridge, comprising:
a housing defining an ink reservoir containing ink, the housing having a leading surface facing in a generally horizontal direction on a front side of the housing;
an ink outlet positioned on the leading surface; and
an air valve arrangement, the air valve arrangement including an air vent positioned on a side of the housing different from the front side, the air valve arrangement actuatable from the front side to create air flow communication between the ink reservoir and the air vent.

20. The ink cartridge of claim 19, wherein the air valve arrangement includes a push rod and an air chamber, the air chamber positioned within the housing and the push rod extending from the front side into the air chamber, the push rod actuatable from the front side in a rearward direction to create the air flow communication.

21. The ink cartridge of claim 20, wherein the air valve arrangement defines an air flow path that extends vertically above and vertically below the push rod.

22. The ink cartridge of claim 20, wherein the air valve arrangement further includes a biasing member that biases the push rod in a direction toward the front side.

23. The ink cartridge of claim 19, wherein the leading surface includes a planar portion that is oriented at an angle relative to a vertical plane.

24. A method of filling an ink cartridge, the ink cartridge including a body portion and a lid portion, the lid portion defining a contoured leading surface of the ink cartridge, the method comprising:
filling the body portion with ink; and
securing the lid portion to the body portion to seal the ink within the ink cartridge.
